(19) United States
(12) Patent Application Publication
(10) Pub. No.: US 2024/0211934 A1
(43) Pub. Date: Jun. 27, 2024

(54) ELECTRONIC WALLET APPLICATION EMERGENCY MODE

(71) Applicant: T-MOBILE INNOVATIONS LLC, Overland Park, KS (US)

(72) Inventor: Gregory David Schumacher, Holliston, MA (US)

(21) Appl. No.: 18/086,015

(22) Filed: Dec. 21, 2022

(51) Int. Cl. G06Q 20/38; G06Q 20/36; G06Q 20/40

(52) U.S. Cl. CPC G06Q 20/3821; G06Q 20/36; G06Q 20/4014; G06Q 20/4015; G06Q 2220/00

(57) ABSTRACT

Systems, methods, and computer-readable media are provided for initiating an emergency mode at an electronic wallet application. An identity of a user is verified based on credentials provided by the user to an electronic wallet application via a user device. The verifying comprises comparing the credentials to normal credentials and emergency credentials. Based on the comparing, it is determined the user has provided emergency credentials to the electronic wallet application. Instructions are provided to the electronic wallet application to transition the electronic wallet application to an emergency mode. Instructions are also provided to the user device to communicate an alert to an emergency services provider.

### SUMMARY

A high-level overview of various aspects of the invention is provided here as an overview of the disclosure and to introduce a selection of concepts further described below in the detailed description. This summary is not intended to identify key features or essential features of the claimed subject matter, nor is it intended to be used as an aid in isolation to determine the scope of the claimed subject matter.

In brief and at a high level, this disclosure describes, among other things, systems, methods, and computer-readable media that initiate an emergency mode at an electronic wallet application. An identity of a user is verified based on credentials provided by the user to an electronic wallet application via a user device. The verifying comprises comparing the credentials to normal credentials and emergency credentials. Based on the comparing, it is determined the user has provided emergency credentials to the electronic wallet application. Instructions are provided to the electronic wallet application to transition the electronic wallet application to an emergency mode. Instructions are also provided to the user device to communicate an alert to an emergency services provider.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts a schematic for an exemplary system, in accordance with an embodiment of the present invention;

FIG. 2 depicts a diagram of an emergency mode engine, in accordance with aspects herein;

FIG. 3 depicts an exemplary method for initiating an emergency mode at an electronic wallet application, in accordance with aspects herein; and

FIG. 4 depicts an exemplary computing device suitable for use in implementations of aspects herein.

### DETAILED DESCRIPTION

The subject matter of select embodiments of the present invention is described with specificity herein to meet statutory requirements. The Detailed Description is not intended to define what is regarded as the invention, which is the purpose of the claims. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention. The following is a list of these acronyms:

| | |
|---|---|
| AWS | Advanced Wireless Services |
| BRS | Broadband Radio Service |
| BTS | Base Transceiver Station |
| CDMA | Code Division Multiple Access |
| EBS | Educational Broadband Services |
| eNodeB | Evolved Node B |
| EVDO | Evolution-Data Optimized |
| gNodeB | Next Generation Node B |
| GPS | Global Positioning System |
| GSM | Global System for Mobile Communications |
| HRPD | High Rate Packet Data |
| eHRPD | Enhanced High Rate Packet Data |
| LTE | Long Term Evolution |
| LTE-A | Long Term Evolution Advanced |
| PCS | Broadband Personal Communications Service |
| RNC | Radio Network Controller |
| SyncE | Synchronous Ethernet |
| TDM | Time-Division Multiplexing |
| VOIP | Voice Over Internet Protocol |
| WAN | Wide Area Network |
| WCS | Wireless Communications Service |
| WiMAX | Worldwide Interoperability for Microwave Access |

Further, various technical terms are used throughout this description. A definition of such terms can be found in, for example, Newton's Telecom Dictionary by H. Newton, 31st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, cryptocurrencies and Web 3.0 are emerging and growing areas that incorporate concepts of decentralization, blockchain technologies, and token-based economics. Currently a number of cryptocurrency users have cryptocurrency wallets or cryptocurrency exchange applications accessible on mobile devices. In some instances, account information including private keys are also stored on the mobile devices to provide convenience of access and ease of making transactions. While there have been a number of cryptocurrency thefts involving large amounts of currency, mostly initiated through social engineering, a new lesser known crime of opportunity has started to emerge.

Unlike bank transfers, cryptocurrency transfers are irreversible, making this crypto-muggings more attractive to thieves. Moreover, cryptocurrency investors and traders often keep large amounts of money in cryptocurrency accounts. However, each individual theft is likely to fall below the radar of law enforcement due to resource limitations and a general lack of understanding and knowledge of cryptocurrency related technologies.

At a high level, systems, methods, and computer-readable media of the present invention initiate an emergency mode at an electronic wallet application. An identity of a user is verified based on credentials provided by the user to an electronic wallet application via a user device (user equipment or UE). The verifying comprises comparing the credentials to normal credentials and emergency credentials. Based on the comparing, it is determined the user has provided emergency credentials to the electronic wallet application. Instructions are provided to the electronic wallet application to transition the electronic wallet application to an emergency mode. Instructions are also provided to the user device to communicate an alert to an emergency services provider.

In this way, aspects herein provide an alternate emergency login/authentication mechanism to access an electronic wallet application on user device. In the case of a normal access (i.e., to initiate a transaction), the user will enter a password or use some form of biometrics (e.g., a fingerprint) to open and login to the electronic wallet application. When the user is under threat/illegal demand the user will have an alternate authentication means to activate the emergency mode. If the authentication is accomplished via a password, the alternate authentication means can simply be a different password. For fingerprint recognition, the alternate authentication means can be a different finger.

In aspects, once the electronic wallet application recognizes the emergency authentication success, it can initiate an emergency (911) type alert without displaying anything unusual in the user interface in case the criminal is either in possession of the phone or watching the interactions of the user. In some aspects, the emergency (911) type alert can use text based messaging to the emergency service (e.g., SMS or emergency messaging) while hiding the interaction and notifying the emergency dispatcher that no user response is possible. The emergency messaging may also provide a location (i.e., per usual 911 service) to enable law enforcement dispatch.

Further, in some aspects, the electronic wallet application can provide false information via the user interface while in emergency mode. The false information may include minimized account balances, delays to transactions (e.g., error messages, timeouts, etc.), limits on transaction sizes, to delay the criminal as long as possible and allow law enforcement to arrive at the scene. Although aspects herein describe electronic wallet applications and utilizes as examples of providers cryptocurrency exchanges or electronic wallet application providers, it is contemplated and within the scope of this disclosure that electronic wallet applications comprise any application or service accessible via a user device that can initiate transfers of value (e.g., a banking application or service, a cold storage wallet, a cryptocurrency application or service such as COINBASE, GOOGLE WALLET, CASH APP, ZELLE, WEBULL, ROBINHOOD, and the like).

Accordingly, in a first aspect of the present invention, computer-readable media is provided, the computer-readable media having computer-executable instructions embodied thereon that, when executed, perform a method for initiating an emergency mode at an electronic wallet application. The method includes verifying, at a silent alarm engine of an electronic wallet application, an identity of a user based on credentials provided by the user to the electronic wallet application via a user device. The verifying comprises comparing the credentials to normal credentials and emergency credentials. The method also comprises, based on the comparing, determining the user has provided emergency credentials to the electronic wallet application. The method further comprises providing instructions to the electronic wallet application to transition the electronic wallet application to an emergency mode. The method also comprises providing instructions to the user device to communicate an alert to an emergency services provider.

In a second aspect of the present invention, a method for initiating an emergency mode at an electronic wallet application is provided. The method includes verifying, at a silent alarm engine of an electronic wallet application, an identity of a user based on credentials provided by the user to the electronic wallet application via a user device. The verifying comprises comparing the credentials to normal credentials and emergency credentials. The method also comprises, based on the comparing, determining the user has provided emergency credentials to the electronic wallet application. The method further comprises providing instructions to the electronic wallet application to transition the electronic wallet application to an emergency mode. The method also comprises providing instructions to the user device to communicate an alert to an emergency services provider.

In a third aspect of the present invention, a system for initiating an emergency mode a user device a silent alarm engine corresponding to an electronic wallet application accessible via the user device. The silent alarm engine verifies an identity of a user based on credentials provided by the user to the electronic wallet application via a user device by comparing the credentials to normal credentials and emergency credentials. The silent alarm engine also determines, based on the comparing, the user has provided emergency credentials to the electronic wallet application. The silent alarm engine further provides instructions to the electronic wallet application to transition to an emergency mode. Emergency mode causes the electronic wallet application to present an alternative interface via the user device and causes a destination address to be recorded for a transaction initiated by the electronic wallet application while in emergency mode.

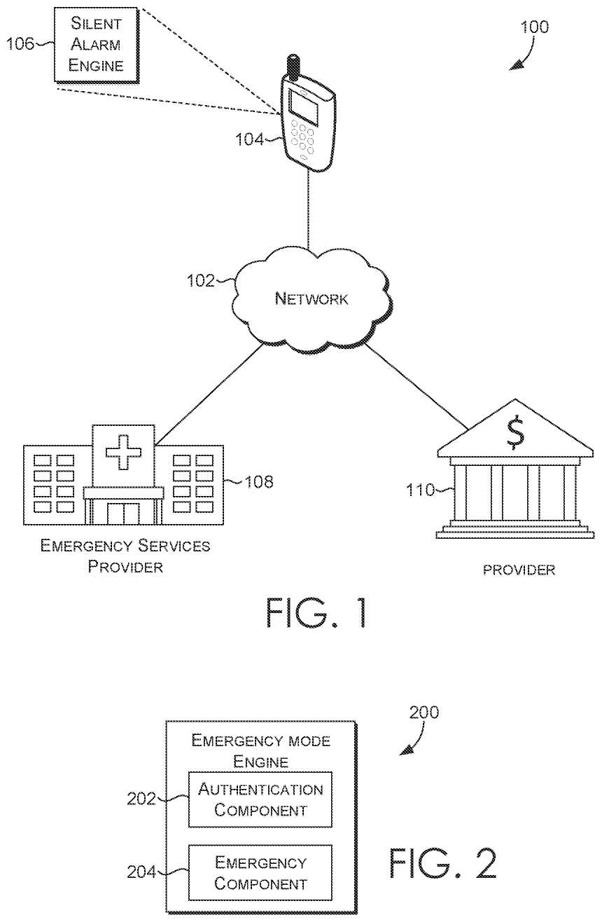

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

As shown in FIG. 1, a communications device may be a UE 104. In the network environment 100, UE 104 may communicate with other devices, such as mobile devices, servers, etc. The UE 104 may take on a variety of forms, such as a personal computer, a laptop computer, a tablet, a netbook, a mobile phone, a Smart phone, a personal digital assistant, or any other device capable of communicating with other devices.

For example, the UE 104 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 104 comprises a wireless or mobile device with which a wireless telecommunication network(s) can be utilized for communication (e.g., voice and/or data communication). In this regard, the UE 104 can be any mobile computing device that communicates by way of, for example, a 5G network.

The UE 104 may utilize network 102 to communicate with other computing devices (e.g., mobile device(s), a server(s), a personal computer(s), etc.) such as emergency services provider 108 or provider (e.g., cryptocurrency exchange 110). In some aspects, network 102 comprises a local area network (LAN) and/or a wide area network (WAN). Such networking environments are commonplace in offices, enterprise-wide computer networks, intranets, and the Internet. In some aspects, network 102 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 102 may include multiple networks, as well as being a network of networks, but is shown in more simple form so as to not obscure other aspects of the present disclosure. Network 102 may be part of a telecommunications network that connects subscribers to their immediate service provider. In embodiments, network 102 is associated with a telecommunications provider that provides services to user devices, such as UE 104. For example, network 102 may provide voice services to user devices or corresponding users that are registered or subscribed to utilize the services provided by a telecommunications provider. Although it is contemplated network 102 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), a 5G network, or the like.

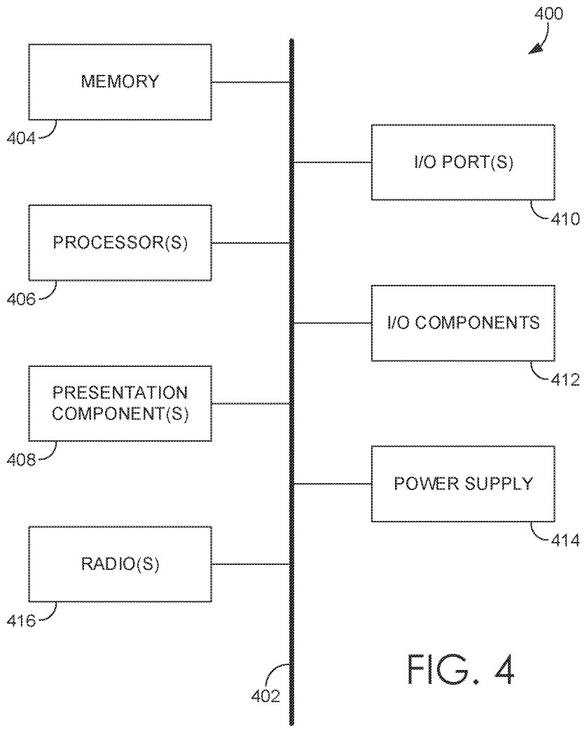

The network environment 100 may include a database (not shown). The database may be similar to the memory component 412 in FIG. 4 and can be any type of medium that is capable of storing information. The database can be any collection of records (e.g., network or device information). In one embodiment, the database includes a set of embodied computer-executable instructions that, when executed, facilitate various aspects disclosed herein. These embodied instructions will variously be referred to as “instructions” or an “application” for short.

Continuing, the network environment 100 may further include a silent alarm engine 106. The silent alarm engine 106 may be configured to, among other things, initiate an emergency mode at an electronic wallet application, in accordance with the present disclosure. Additionally or alternatively, the silent alarm engine 106 may engage operations support systems at a core network to provide instructions to the node to automatically make angular or power adjustments for a lobe provided by at least the portion of the node. Though the silent alarm engine 106 is illustrated as a component of UE 104 in FIG. 1, it may be a standalone device (e.g., a server having one or more processors), a component of the UE 104, a component of the provider 110 (e.g., cryptocurrency exchange or electronic wallet application provider), an application or service corresponding to the provider and provided via the network 102, may be remotely located, or any combination thereof.

Referring now to FIG. 2, the silent alarm engine 106 may include, among other things, authentication component 202 and emergency component 204. The silent alarm engine 106 may communicate data to or receive data from user devices, such as UE 104, emergency services provider 108, and/or provider 110 (e.g., cryptocurrency exchange or electronic wallet application provider).

Authentication component 202 generally receives credentials provided by a user to an electronic wallet application (or other application or service as described herein) via a user device. Authentication component verifies the credentials by comparing them to normal credentials and emergency credentials. For clarity, normal credentials enable the user to access the electronic wallet application to perform functions and transactions under ordinary circumstances. In contrast, as described in more detail below, emergency credentials enable the user to access the electronic wallet application in an emergency mode that may disable, prevent, or delay the functions and transactions available under ordinary circumstances.

Emergency component 204 generally determines, based on the comparing, whether the user has provided emergency credentials to the electronic wallet application. Upon determining the user has provided emergency credentials, emergency component 204 provides instructions to the electronic wallet application to transition the electronic wallet application to an emergency mode.

In some aspects, emergency component 204 provides instructions to the user device to communicate an alert to an emergency services provider. In some aspects, the alert the includes a location of the user device, a message indicating a suspected robbery is in progress, and a notification to not communicate back to the user device. Additionally or alternatively, emergency component 204 communicates the alert to a provider associated with a transaction initiated at the electronic wallet application while in emergency mode.

Moreover, emergency component 204 may initiate one or more intervening actions at the electronic wallet application. For example, emergency component 204 may cause the electronic wallet application to present an alternative interface that minimizes a balance associated with the user of the electronic wallet application or falsely indicates that a transaction has been processed. In another example, emergency component 204 may cause a destination address (or, in some aspects, a destination account) to be recorded for a transaction initiated at the electronic wallet application while in emergency mode. Additionally or alternatively, emergency component 204 may communicate the destination address to a provider associated with the transaction and the emergency services provider.

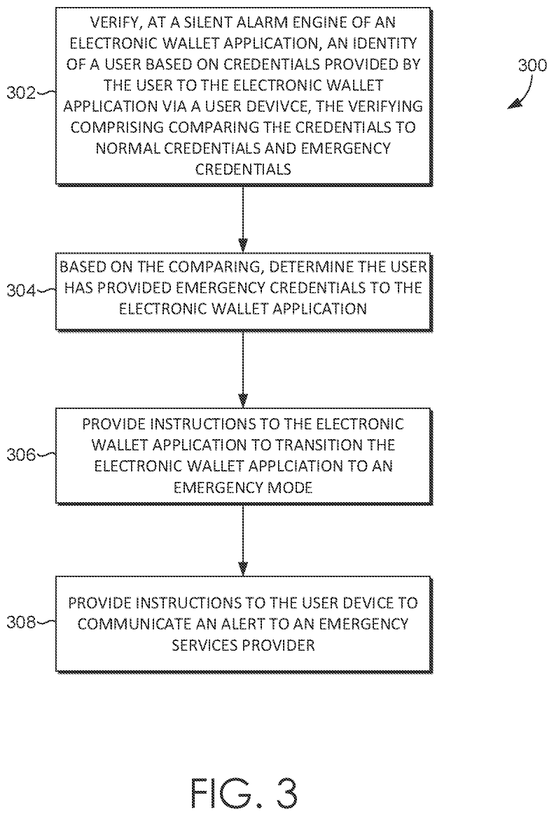

Turning now to FIG. 3, flow diagram 300 comprises an exemplary method for initiating an emergency mode at an electronic wallet application. Initially at step 302, an identity of a user is verified at an electronic wallet application based on credentials provided by the user to the electronic wallet application via a user device. The verifying comprises comparing the credentials to normal credentials and emergency credentials. For example, during account setup (or anytime thereafter) the user may configure two distinct sets of credentials with the electronic wallet application. One set of credentials (i.e., the normal credentials) enables the user to login to the electronic wallet application and use the electronic wallet application as intended for normal use. The other set of credentials (i.e., the emergency credentials) enables the user to login to an interface that appears as though the user has logged in normally to the electronic wallet application, but is operating in emergency mode.

At step 304, based on the comparing, it is determined the user has provided emergency credentials to the electronic wallet application. Accordingly, instructions are provided, at step 306, to the electronic wallet application to transition the electronic wallet application to an emergency mode. Additionally, instructions are provided, at step 308, to the user device to communicate an alert to an emergency services provider.

In some aspects, the alert the includes a location of the user device, a message indicating a suspected robbery is in progress, and a notification to not communicate back to the user device. In some aspects, the alert may also be communicated to a provider associated with a transaction initiated at the electronic wallet application while in emergency mode. For example, the provider may be a financial services provider of the user. In this instance, an alert may be provided to the financial services provider so the financial services provider understands that a possible crime is underway so the provider does not process any fraudulent transactions. Additionally or alternatively, the provider may be an electronic wallet application or financial services provider of the criminal. In this instance, an alert may be provided to the electronic wallet application or financial services provider of the criminal designating the account of the criminal as being associated with fraud.

While in emergency mode, the electronic wallet application may operate differently than in normal mode. For example, one or more intervening actions may be initiated at the electronic wallet application. Based on initiating one or more intervening actions, the electronic wallet application may present an alternative interface via the user device. In some aspects, the alternative interface minimizes a balance associated with the user of the electronic wallet application. This makes it appear to the criminal that the user may not be a good target of the fraud because the electronic wallet application displays a false balance that is less than the actual balance of the user. If the criminal or user initiates a transaction, the alternative interface may falsely indicate that a transaction has been processed so the criminal does not suspect that the emergency services provider or the provider have been alerted.

In some aspects, based on initiating the one or more intervening actions, a destination address is recorded for a transaction initiated at the electronic wallet application while in emergency mode. This enables the transaction to be traced to the criminal committing the fraud. Moreover, the destination address can be reported to the emergency services provider and the provider.

Referring now to FIG. 4, a diagram is depicted of an exemplary computing environment suitable for use in implementations of the present disclosure. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 4, computing device 400 includes bus 402 that directly or indirectly couples the following devices: memory 404, one or more processors 406, one or more presentation components 408, input/output (I/O) ports 410, I/O components 412, power supply 414 and radio(s) 416. Bus 402 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component, such as a display device to be one of I/O components 412. Also, processors, such as one or more processors 406, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 404 includes computer-storage media in the form of volatile and/or nonvolatile memory. Memory 404 may be removable, non-removable, or a combination thereof. Exemplary memory includes solid-state memory, hard drives, optical-disc drives, etc. Computing device 400 includes one or more processors 406 that read data from various entities, such as bus 402, memory 404, or I/O components 412. One or more presentation components 408 presents data indications to a person or other device. Exemplary one or more presentation components 408 include a display device, speaker, printing component, vibrating component, etc. I/O ports 410 allow computing device 400 to be logically coupled to other devices, including I/O components 412, some of which may be built in computing device 400. Illustrative I/O components 412 include a microphone, joystick, game pad, satellite dish, scanner, printer, wireless device, etc.

Radio 416 represents a radio that facilitates communication with a wireless telecommunications network. Illustrative wireless telecommunications technologies include CDMA, GPRS, TDMA, GSM, and the like. Radio 416 might additionally or alternatively facilitate other types of wireless communications including Wi-Fi, WiMAX, LTE, or other VoIP communications. As can be appreciated, in various embodiments, radio 416 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. One or more computer-readable media having computer-executable instructions embodied thereon that, when executed, perform a method for initiating an emergency mode at an electronic wallet application, the method comprising:
verifying, at a silent alarm engine of an electronic wallet application, an identity of a user based on credentials provided by the user to the electronic wallet application via a user device, the verifying comprising comparing the credentials to normal credentials and emergency credentials;
based on the comparing, determining the user has provided emergency credentials to the electronic wallet application;
providing instructions to the electronic wallet application to transition the electronic wallet application to an emergency mode; and
providing instructions to the user device to communicate an alert to an emergency services provider.

2. The media of claim 1, wherein the alert the includes a location of the user device, a message indicating a suspected robbery is in progress, and a notification to not communicate back to the user device.

3. The media of claim 1, further comprising communicating the alert to a provider associated with a transaction initiated at the electronic wallet application while in emergency mode;

4. The media of claim 1, further comprising initiating one or more intervening actions at the electronic wallet application.

5. The media of claim 4, further comprising, based on initiating the one or more intervening actions, causing the electronic wallet application to present an alternative interface via the user device.

6. The media of claim 5, wherein the alternative interface minimizes a balance associated with the user of the electronic wallet application.

7. The media of claim 5, wherein the alterative interface falsely indicates that a transaction has been processed.

8. The media of claim 4, further comprising, based on initiating the one or more intervening actions, causing a destination address to be recorded for a transaction initiated at the electronic wallet application while in emergency mode.

9. The media of claim 8, further comprising reporting the destination address to a provider associated with the transaction and the emergency services provider.

10. A method for initiating an emergency mode at an electronic wallet application, the method comprising:
verifying, at a silent alarm engine of an electronic wallet application, an identity of a user based on credentials provided by the user to the electronic wallet application via a user device, the verifying comprising comparing the credentials to normal credentials and emergency credentials;
based on the comparing, determining the user has provided emergency credentials to the electronic wallet application;
providing instructions to the electronic wallet application to transition to an emergency mode; and
providing instructions to the user device to communicate an alert to an emergency services provider.

11. The method of claim 10, wherein the alert includes a location of the user device, a message indicating a suspected robbery is in progress, and a notification to not communicate back to the user device.

12. The method of claim 10, further comprising communicating the alert to a provider associated with a transaction initiated at the electronic wallet application while in emergency mode.

13. The method of claim 10, further comprising initiating one or more intervening actions at the electronic wallet application.

14. The method of claim 13, further comprising, based on initiating the one or more intervening actions, causing the electronic wallet application to present an alternative interface via the user device.

15. The method of claim 14, wherein the alternative interface minimizes a balance associated with the user of the electronic wallet application.

16. The method of claim 14, wherein the alterative interface falsely indicates that a transaction has been processed.

17. The method of claim 13, further comprising, based on initiating the one or more intervening actions, causing a destination address to be recorded for a transaction initiated at the electronic wallet application while in emergency mode.

18. The method of claim 17, further comprising reporting the destination address to a provider associated with the transaction and the emergency services provider.

19. A system for initiating an emergency mode at an electronic wallet application, the system comprising:
a user device; and
a silent alarm engine corresponding to an electronic wallet application accessible via the user device, the silent alarm engine:
(1) verifying an identity of a user based on credentials provided by the user to the electronic wallet application via a user device by comparing the credentials to normal credentials and emergency credentials;
(2) based on the comparing, determining the user has provided emergency credentials to the electronic wallet application; and
(3) providing instructions to the electronic wallet application to transition to an emergency mode, wherein emergency mode causes the electronic wallet application to present an alternative interface via the user device and causes a destination address to be recorded for a transaction initiated by the electronic wallet application while in emergency mode.

20. The system of claim 19, wherein the alternative interface minimizes a balance associated with the user of the electronic wallet application or falsely indicates that a transaction has been processed.
